(19) United States
(12) Patent Application Publication
(10) Pub. No.: US 2024/0338835 A1
(43) Pub. Date: Oct. 10, 2024

(54) DUAL IMAGE PROCESSING

(71) Applicant: Apple Inc., Cupertino, CA (US)

(72) Inventors: Mikael B. MANNBERG, San Jose, CA (US); Tyler M. MAU, San Diego, CA (US); Roddy M. SHULER, Palo Alto, CA (US); George E. WILLIAMS, Pleasanton, CA (US)

(21) Appl. No.: 18/438,363

(22) Filed: Feb. 9, 2024

Related U.S. Application Data
(60) Provisional application No. 63/458,013, filed on Apr. 7, 2023.

(51) Int. Cl. G06T 7/50

(52) U.S. Cl. CPC G06T 7/50

(57) ABSTRACT

Some techniques described herein include an image processing system that maintains certain regions of an image at a higher resolution than other regions. Such techniques can include performing operations (e.g., generating or adding to a depth map) on regions of the same resolution.

### CROSS-REFERENCE TO RELATED APPLICATIONS

The present application claims priority to U.S. Provisional Patent Application Ser. No. 63/458,013, entitled “DUAL IMAGE PROCESSING” filed Apr. 7, 2023, which is hereby incorporated by reference in its entirety for all purposes.

### BACKGROUND

Image processing systems often process and send images between devices in a network. Such operations sometimes require different amounts of resources depending on the images processed and/or sent. For example, an image with a greater resolution can require greater resources to process and/or send the image than an image with a lower resolution.

### SUMMARY

Current techniques for image processing systems are generally ineffective and/or inefficient. This disclosure provides more effective and/or efficient techniques for implementing an image processing system using an example of multiple cameras (e.g., 2-10) capturing images of an overlapping field of view (e.g., a substantially overlapping field of view, such as more than 75% overlapping). It should be recognized that an image processing system is one example of a data processing system and other types of data processing systems are within the scope of and can benefit from techniques described herein. For example, a location processing system can benefit from techniques described herein when processing and sending data with respect to a current location that is separately detected by different components. In addition, techniques described herein optionally complement or replace other data processing systems.

In one example, some techniques include an image processing system that intelligently maintains certain regions of an image at a higher resolution than other regions so that each region of the image is not at the higher resolution. In such an example, one or more regions of the image at the higher resolution can correspond to parts of a field of view that would likely benefit from higher resolution. Such techniques can include contextual selection of a part of a field of view to perform an operation (e.g., generating a depth map and/or adding to a depth map) and maintaining higher resolution in one or more regions of images of the field of view that correspond to the part of the field of view. In some examples, the part of the field of view is changed (e.g., moved and/or enlarged/shrunk) over time such that different regions of images are maintained at the higher resolution at different times. In such examples, a computer system changes the part of the field of view based on a determination that a different part of the field of view would likely benefit from higher resolution.

In another example, some techniques include an image processing system with multiple different pipelines for generating depth maps using images having different resolutions, where the images are combined into a single depth map. Such techniques can include capture of multiple images with an overlapping field of view. A corresponding region of the multiple images is maintained at a higher resolution and used to generate a first depth map for a part of the field of view. Another corresponding region of the multiple images is downsampled and used to generate a second depth map that is then combined with the first depth map.

In some examples, a method performed at a device that is in communication with a first camera and a second camera is described. In some examples, the method comprises: receiving, from the first camera, a first image of a physical environment; receiving, from the second camera, a second image of the physical environment, wherein the second image includes an overlapping field of view with respect to the first image; based on a context of the device, selecting: a first portion, from the first image, of the overlapping field of view, wherein the first image includes a portion of the overlapping field of view separate from the first portion; and a second portion, from the second image, of the overlapping field of view, wherein the second image includes a portion of the overlapping field of view separate from the second portion; and after selecting the first portion and the second portion, performing a first operation using the first portion and the second portion.

In some examples, a non-transitory computer-readable storage medium storing one or more programs configured to be executed by one or more processors of a device that is in communication with a first camera and a second camera is described. In some examples, the one or more programs includes instructions for: receiving, from the first camera, a first image of a physical environment; receiving, from the second camera, a second image of the physical environment, wherein the second image includes an overlapping field of view with respect to the first image; based on a context of the device, selecting: a first portion, from the first image, of the overlapping field of view, wherein the first image includes a portion of the overlapping field of view separate from the first portion; and a second portion, from the second image, of the overlapping field of view, wherein the second image includes a portion of the overlapping field of view separate from the second portion; and after selecting the first portion and the second portion, performing a first operation using the first portion and the second portion.

In some examples, a transitory computer-readable storage medium storing one or more programs configured to be executed by one or more processors of a device that is in communication with a first camera and a second camera is described. In some examples, the one or more programs includes instructions for: receiving, from the first camera, a first image of a physical environment; receiving, from the second camera, a second image of the physical environment, wherein the second image includes an overlapping field of view with respect to the first image; based on a context of the device, selecting: a first portion, from the first image, of the overlapping field of view, wherein the first image includes a portion of the overlapping field of view separate from the first portion; and a second portion, from the second image, of the overlapping field of view, wherein the second image includes a portion of the overlapping field of view separate from the second portion; and after selecting the first portion and the second portion, performing a first operation using the first portion and the second portion.

In some examples, a device that is in communication with a first camera and a second camera is described. In some examples, the device comprises one or more processors and memory storing one or more program configured to be executed by the one or more processors. In some examples, the one or more programs includes instructions for: receiving, from the first camera, a first image of a physical environment; receiving, from the second camera, a second image of the physical environment, wherein the second image includes an overlapping field of view with respect to the first image; based on a context of the device, selecting: a first portion, from the first image, of the overlapping field of view, wherein the first image includes a portion of the overlapping field of view separate from the first portion; and a second portion, from the second image, of the overlapping field of view, wherein the second image includes a portion of the overlapping field of view separate from the second portion; and after selecting the first portion and the second portion, performing a first operation using the first portion and the second portion.

In some examples, a device that is in communication with a first camera and a second camera is described. In some examples, the device comprises means for performing each of the following steps: receiving, from the first camera, a first image of a physical environment; receiving, from the second camera, a second image of the physical environment, wherein the second image includes an overlapping field of view with respect to the first image; based on a context of the device, selecting: a first portion, from the first image, of the overlapping field of view, wherein the first image includes a portion of the overlapping field of view separate from the first portion; and a second portion, from the second image, of the overlapping field of view, wherein the second image includes a portion of the overlapping field of view separate from the second portion; and after selecting the first portion and the second portion, performing a first operation using the first portion and the second portion.

In some examples, a computer program product is described. In some examples, the computer program product comprises one or more programs configured to be executed by one or more processors of a device that is in communication with a first camera and a second camera. In some examples, the one or more programs include instructions for: receiving, from the first camera, a first image of a physical environment; receiving, from the second camera, a second image of the physical environment, wherein the second image includes an overlapping field of view with respect to the first image; based on a context of the device, selecting: a first portion, from the first image, of the overlapping field of view, wherein the first image includes a portion of the overlapping field of view separate from the first portion; and a second portion, from the second image, of the overlapping field of view, wherein the second image includes a portion of the overlapping field of view separate from the second portion; and after selecting the first portion and the second portion, performing a first operation using the first portion and the second portion.

Executable instructions for performing these functions are, optionally, included in a non-transitory computer readable storage medium or other computer program product configured for execution by one or more processors. Moreover, details of one or more examples, implementations, and/or embodiments are set forth in the accompanying drawings and the description below. Other components, features, aspects, and potential advantages will be apparent from the description and drawings, and from the claims.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some examples described herein.

FIG. 2 is a block diagram illustrating a device with interconnected subsystems in accordance with some examples described herein.

FIG. 3 is a block diagram illustrating an image processing system capturing and processing different images in accordance with some examples described herein.

FIGS. 4A-4C are block diagrams illustrating selection of different regions in images in accordance with some examples described herein.

FIG. 5 is a flow diagram illustrating a method for contextual selection of a portion of a field of view in accordance with some examples described herein.

FIG. 6 is a flow diagram illustrating a method for separately generating depth maps using images with different resolutions in accordance with some examples described herein.

### DETAILED DESCRIPTION

The following description sets forth exemplary techniques, methods, parameters, systems, computer-readable storage mediums, and the like. It should be recognized, however, that such description is not intended as a limitation on the scope of the present disclosure. Instead, such description is provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described embodiments. In some examples, the first subsystem and the second subsystem are two separate references to the same subsystem. In some embodiments, the first subsystem and the second subsystem are both subsystem, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

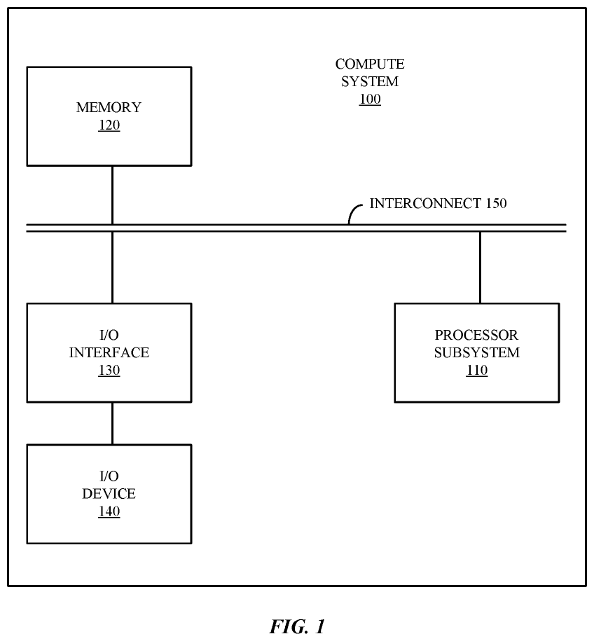

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more I/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included or communicating with a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 800, 900, 1000, 11000, 12000, 1300, 1400, and 1500 described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

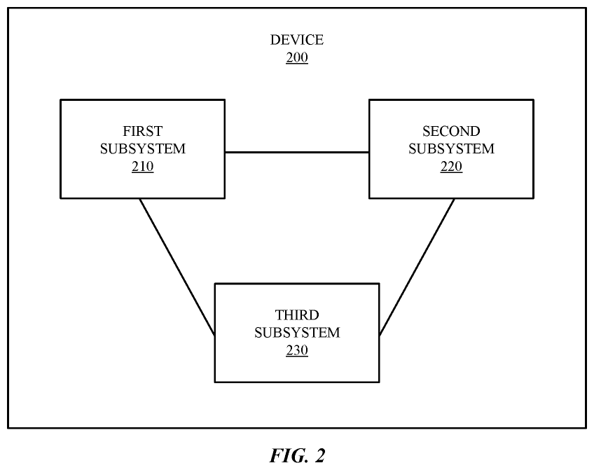

FIG. 2 illustrates a block diagram of device 200 with interconnected subsystems in accordance with some examples described herein. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

Attention is now directed towards techniques for implementing an image processing system. Such techniques are described in the context of an image processing system with multiple cameras (e.g., 2-10) capturing images of an overlapping field of view. It should be understood that other types of systems are within scope of this disclosure and can benefit from techniques described herein. For example, a single camera can capture multiple images that are each used as if from a different camera in view of the techniques described below.

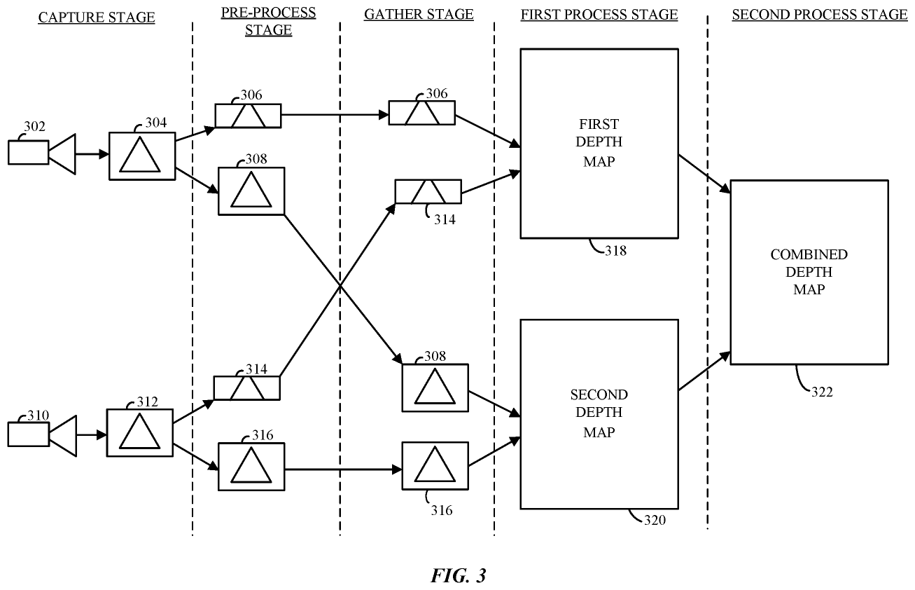

FIG. 3 is a block diagram illustrating an image processing system capturing and processing different images. The block diagram includes vertical dotted lines to separate different stages of processing. It should be recognized that the stages are illustrated for discussion purposes only, that the stages can be repeated and/or be in a different order, and that more or fewer stages can be used.

The image processing system in FIG. 3 includes two cameras (e.g., camera 302 and camera 310). In some examples, camera 302 and/or camera 312 include one or more components of compute device 100 and/or device 200. In some examples, the two cameras are attached to a housing of a single device and directed such that each camera captures an image, where each image includes an overlapping field of view in a physical environment. It should be recognized that the image processing system does not need to include a camera and can instead receive images from another system (e.g., a remote system, a remote database, and/or a system that is in communication with the image processing system).

As illustrated by FIG. 3 in the capture stage, camera 302 captures an image (i.e., image 304) of a triangle that is partially in the field of view of camera 302. In some examples, image 304 is captured by camera 302 and stored in memory corresponding to camera 302. Such memory can be local to camera 302. In other examples, image 304 is captured by camera 302 and stored in memory corresponding to a device different from camera 302, such as compute system 100 or device 200. The same, similar, and/or different operations can be performed by camera 310 to capture image 312. In some examples, image 304 is captured at approximately the same time as image 312. In other examples, each image is captured at a different time.

As illustrated by FIG. 3 in the pre-process stage, one or more pre-processing operations are performed on image 304. In some examples, the one or more pre-processing operations are performed by a processor of camera 302. In other examples, the one or more pre-processing operations are performed by a processor of a different device than camera 302. For example, camera 302 can send image 304 to the different device to have the one or more pre-processing operations performed. In other examples, some pre-processing operations are performed by a processor of camera 302 while other pre-processing operations are performed by the different device. Examples of pre-processing operations include cropping an image, rotating an image, translating an image from one format to a different format (e.g., from RGB to YUV), reducing the resolution of an image, rectifying an image, and/or any other operation to modify an image. Such pre-processing operations can be performed in different orders and one or more processing operations (as discussed further below) can be performed between or after different pre-processing operations. In some examples, particular pre-processing operations are performed with respect to images captured by particular cameras in particular contexts. For example, when images from two or more cameras are being used to identify objects further away, the images can be downsampled less or not at all as opposed to, when images from two or more cameras are being used to identify objects closer away, the images can be downsampled more.

FIG. 3 illustrates that image 304 is cropped to generate image 306 and downsampled to generate image 308. In some examples, image 306 is also downsampled though a greater or lesser amount as compared to image 308. It should be recognized that one or more pre-processing operations can be performed in-memory such that image 304 is modified to be image 306 or image 308. In one example, a separate image (e.g., image 308) is generated from image 304 when downsampling image 304. In such an example, image 304 is not affected by the downsampling and, after creating image 308, image 304 is cropped in memory to create image 306 (e.g., having a higher resolution than image 308). The same, similar, and/or different operations can be performed on image 312 to generate image 314 and image 316. In some examples, more images are generated from one or more pre-processing operations, each additional image with the same one or more pre-processing operations used in a different pipeline to be separately processed in further stages (e.g., the gather, first process, and/or second process stage of FIG. 3).

As illustrated by FIG. 3 in the gather stage, image 306 and image 314 are gathered together. In some examples, gathering includes storing image 306 and image 314 in memory accessible by one or more processors. In one example, one of image 306 and image 314 is stored in memory where the other image is stored such that only one of the images needs to be moved. In other examples, gathering includes identifying a memory location of image 306 and image 314 without storing either image in a different location. Such memory locations can then be used to perform one or more processing operations, as discussed further below. The same, similar, and/or different operations can be performed for image 308 and image 316 in the gather stage. In some examples, images that have had similar pre-processing operations performed are gathered together so that processing operations requiring two different images can be performed.

After the capture stage and, in some examples, after the gather stage, one or more processing operations are performed. Such processing operations can relate to processing content of the images and require comparison and/or analysis of one or more pixels of images that are gathered (e.g., image 306 and image 314). In some examples, different processing operations are performed on different images and/or different stages of an image at the same or different times. For example, a first object identification operation can be performed on image 304 (e.g., before and/or after generating image 306), a second object identification operation can be performed on image 306, and a third object identification object can be performed using image 306 and image 314.

As illustrated by FIG. 3 in the first process stage, first depth map 318 is generated using image 306 and image 314, and second depth map 320 is generated using image 308 and image 316. In some examples, first depth map 318 is a higher resolution depth map than second depth map 320 due to the images used for first depth map 318 being higher resolution than the images used for second depth map 320. In such examples, second depth map 320 can include depth points for a larger part of the field of view than first depth map 318 due to image 308 and image 316 not being cropped the same amount as image 306 and image 314 are cropped. In some examples, points in a depth map are associated with a confidence level (e.g., an amount of certainty that a depth for a particular point is correct) and a time offset (e.g., the time offset between the image and another image intended to be used together with the image). In such examples, the confidence level and/or the time offset can be used when performing other processing operations, such as combining depth maps as discussed below.

As illustrated by FIG. 3 in the second process stage, combined depth map 322 is generated using first depth map 318 and second depth map 320. In some examples, combined depth map 322 combines points included in first depth map 318 and points included in second depth map 320. For example, second depth map 320 can include points that are not included in first depth map 318 and those points can be copied from second depth map 320 to combined depth map 322. In some examples, first depth map 318 is higher resolution than second depth map 320 such that points included in first depth map 318 are determined to be trusted more than second depth map 320 and copied regardless of whether similar points are included in second depth map 320. In other examples, points in first depth map 318 and second depth map 320 are combined such that points from both depth maps are taken into account when generating combined depth map 322. For example, a point in first depth map 318 can be averaged with a point in second depth map 320 to generate a combined point in combined depth map 322. It should be recognized that more or fewer process stages can be performed. For example, one or more process stages can be performed using combined depth map 322, such as to identify a distance that an object is from camera 302 and camera 310.

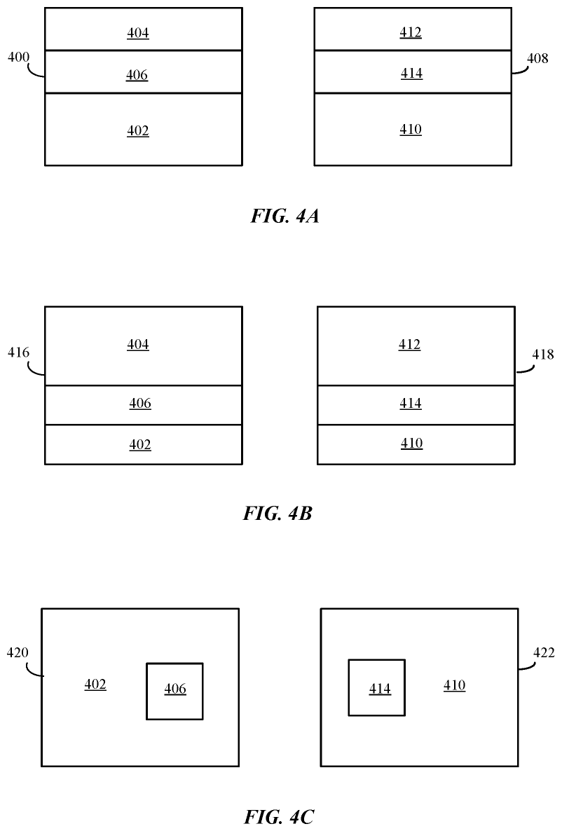

FIGS. 4A-4C are block diagrams illustrating context-dependent pre-processing techniques. In particular, each figure in FIGS. 4A-4C illustrates a different way that images can be divided depending on a current context. In some examples, the current context determines how an image is divided, for example to be used to perform different operations on each divided region. In one example, a region of an image is cropped and maintained at a higher resolution than the image overall (referred to as a second image) such that the region can be analyzed when higher resolution is required and the second image can be analyzed when lower resolution is acceptable. In such an example, two or more different images of an overlapping field of view can be cropped such that the cropped portions correspond to the same part of an overlapping field of view as determined by calibration (e.g., internal and/or external calibration such as predefining which regions of images from different cameras correspond to each other). It should be recognized that such cropping does not need to be rectangular and instead can be any shape.

In some examples, a set of cameras (e.g., one or more cameras) is used to capture images of a physical environment. In such examples, the images can be analyzed to identify an arca (e.g., a part, a portion, and/or a region) of the physical environment (and/or, in some examples, of a field of view) of importance (e.g., a current context). Then, based on the analysis, subsequent images of the physical environment by the set of cameras or a different camera are able to be divided such that the part of the field of view is pre-processed and/or processed (as described above) differently from other parts of the field of view. In some examples, such division can occur by identifying a region of pixels of an image, where the pixels correspond to the area and cropping the region of pixels in any subsequent image. In other examples, such division can occur by identifying an object included in the region in a subsequent image that matches an object included in the region in a previous image and cropping the region of pixels corresponding to the object in the subsequent image.

In some examples, the current context relates to a current characteristic (e.g., based on a sensor detecting an environmental state or a current state (e.g., on, off, and/or fault) of a component (e.g., a different camera) of the device) or future (e.g., based on a determination with respect to a subsequent operation to be performed by the device) characteristic of a device, such as a speed, acceleration, or movement direction. In such examples, based on the characteristic of the device, an image is divided to compensate for the characteristic. For example, when the device is moving faster, a region of the image that corresponds to a three-dimension space further along an intended path (e.g., resulting in a larger region of the image) can be maintained at a higher resolution than when the device is moving slower.

In some examples, the current context relates to a location of the device, such as determined through a global positioning system (GPS). In such examples, the location of the device causes different regions of an image to be important based on knowledge of a physical environment corresponding to the location. For example, when a first image is determined to correspond to a first location of an environment that includes an incline, a first region of the image (e.g., a region that is higher in the image, such as a region that is normally the sky when there is not an incline) can be determined to be more important (e.g., and maintained at a higher resolution) than a second region (e.g., a region that is lower in the image, such as a region that is normally where objects are located when there is not an incline) of the image. In such an example, when a second image is determined to correspond to a second location of the environment that does not include an incline, the second region of the second image can be determined to be more important (e.g., and maintained at higher resolution) than the first region of the second image (e.g., different regions of an image are maintained at a higher resolution depending on a location that the image is capturing).

FIG. 4A is a block diagram illustrating images (e.g., image 400 and image 408) divided into three regions: a lower region (e.g., lower region 402 and lower region 410), an upper region (e.g., upper region 404 and upper region 412), and a middle region (e.g., middle region 406 and middle region 414). In some examples, such regions are selected based on a determination that a part of a physical environment (and/or, in some examples, of a field of view) corresponding to middle region 406 and/or middle region 414 is likely to include content that requires different pre-processing and/or processing operations to be performed on it than another part of the physical environment (and/or, in some examples, of the field of view).

Such regions of FIG. 4A can be used with techniques described above with respect to FIG. 3. For example, image 400 can correspond to image 304 and image 308, middle region 406 can correspond to image 306, image 408 can correspond to image 312 and image 316, and middle region 414 and correspond to image 314. For another example, lower region 402 and/or upper region 404 can correspond to image 308, middle region 406 can correspond to image 306, lower region 410 and/or upper region 412 can correspond to image 316, and middle region 414 can correspond to image 314.

FIG. 4B is a block diagram illustrating that the middle regions (e.g., middle region 406 and middle region 414) have been moved down relative to the image as a whole as illustrated in FIG. 4A. In other words, middle region 406 in image 416 is lower in the image relative to middle region 406 in image 400. Such movement of middle region 406 can occur in response to (e.g., be caused by) a determination that a part of a physical environment (and/or, in some examples, of the field of view) corresponding to updated location of middle region 406 and/or middle region 414 is likely to include content that requires different pre-processing and/or processing operations to be performed on it than another part of the physical environment (and/or, in some examples, of the field of view). It should be noticed that the size of middle regions in FIG. 4B have not changed as compared to FIG. 4A and that the middle regions have instead translated down. In some examples, the middle regions do not change size but rather only change location.

FIG. 4C is a block diagram illustrating a different shape and size of middle region as compared to FIGS. 4A-4B. In particular, middle region 406 and middle region 414 no longer take up the width of the images (e.g., image 420 and image 422) but rather have been narrowed. Such change to the middle regions can occur in response to (e.g., be caused by) a determination that a part of a physical environment (and/or, in some examples, of the field of view) corresponding to middle region 406 and/or middle region 414 is likely to include content that requires different pre-processing and/or processing operations to be performed on it than another part of the physical environment (and/or, in some examples, of the field of view).

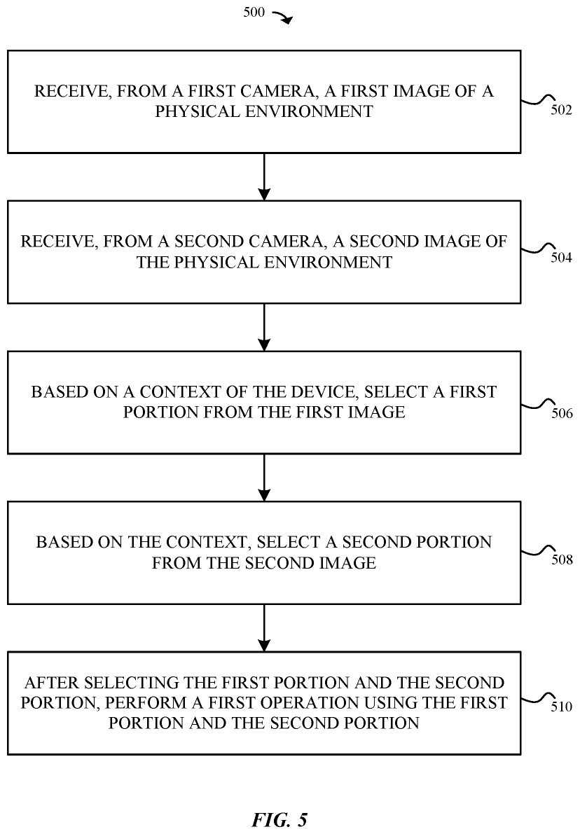

FIG. 5 is a flow diagram illustrating method 500 for contextual selection of a portion of a field of view in accordance with some examples described herein. Some operations in method 500 are, optionally, combined, the orders of some operations are, optionally, changed, and some operations are, optionally, omitted.

In some examples, method 500 is performed at a device (e.g., a phone, robotic device, a tablet, a motorized device, a wearable device, a personal computer, a robot vacuum, and/or an autonomous device) that is in communication with (e.g., including) a first camera and a second camera (e.g., different from the first camera). In some examples, the device includes one or more wheels, one or more brakes, one or more steering systems (e.g., a steering system includes an axel), one or more suspension systems (e.g., a suspension system includes a shock absorber), or any combination thereof. In some examples, the first and/or second camera is connected via at least one or more wires to one or more processors of the device. In some examples, the first and/or the second camera is wirelessly connected to one or more processors of the device. In some examples, the one or more processors are included in a component of the device separate from the first and the second camera. In some examples, the one or more processors are included in the first and/or the second camera. In some examples, a plurality of processors of a device perform the method, where at least one step is performed by one or more processors on a first system on a chip (i.e., SoC) and a second step is performed by a second SoC, and where the first SoC and the second SoC are distributed in different locations on the device, where the different locations are separated by at least 12-36 inches.

At 502, the device receives, from the first camera, a first image (e.g., a representation of a physical environment) of a physical environment. In some examples, the first image includes one or more color channels, such as red, green, and blue or an amount of light. In some examples, receiving the first image from the first camera means that the first camera captures an image that is then processed to generate the first image.

At 504, the device receives, from the second camera, a second image (e.g., a representation of a physical environment) of the physical environment, wherein the second image includes an overlapping field of view with respect to the first image (e.g., the first image captures a first field of view, the second image captures a second field of view, and the second field of view is at least partially overlapping of the first field of view). In some examples, the second image includes one or more color channels, such as red, green, and blue or an amount of light. In some examples, receiving the second image from the second camera means that the second camera captures an image that is then processed to generate the second image.

At 506, based on a context of the device, the device selects a first portion, from the first image, of (e.g., within or included in) the overlapping field of view, wherein the first image includes a portion of the overlapping field of view separate from the first portion (e.g., the first image includes a third portion of the overlapping field of view that is different from the first portion; e.g., the first image captures a first field of view that includes both the first and third portion). In some examples, in response to a determination that the device is in a first context, the first portion is selected.

At 508, based on the context of the device, the device selects a second portion, from the second image, of the overlapping field of view, wherein the second image includes a portion of the overlapping field of view separate from the second portion (e.g., the second image includes a fourth portion of the overlapping field of view that is different from the second portion; e.g., the second image captures a second field of view that includes both the second and fourth portion). In some examples, different portions of the overlapping field of view are selected when the device is in different contexts. In some examples, the device determines the context and the selecting is performed in response to determining the context. In some examples, in response to a determination that the device is in a second context, the second portion is selected.

At 510, the device, after selecting the first portion and the second portion, performs (e.g., executes) a first operation using the first portion and the second portion. In some examples, the performing of the first operation is in response to the selecting the first portion or the second portion. In some examples, the first operation does not use a portion of an image outside of the first portion and the second portion.

In some examples, performing the first operation includes: calculating a depth of a location within the physical environment. In some examples, the operation includes calculating depths for a plurality of locations within the physical environment. In some examples, performing the first operation includes adding the depth of the location to a depth map for the physical environment. In some examples, multiple depths are added to the depth map for the physical environment by the first operation.

In some examples, the device, after receiving the first image and the second image, receives, from the first camera, a third image of the physical environment, wherein the third image is separate from the first image and the second image. In some examples, the device, after receiving the first image and the second image, receives, from the second camera, a fourth image of the physical environment, wherein the fourth image is separate from the first image, the second image, and the third image, and wherein the fourth image includes a second overlapping field of view with respect to the third image. In some examples, the second overlapping field of view is the overlapping field of view. In some examples, the device, based on a second context of the device, selects a third portion, from the third image, of the second overlapping field of view, wherein a portion of the third image corresponding to the first portion is a different area within the second overlapping field of view, wherein the third portion is the same size as the first portion. In some examples, the device, based on the second context of the device, selects a fourth portion, from the fourth image, of the second overlapping field of view, wherein a portion of the fourth image corresponding to the second portion is a different area within the second overlapping field of view, wherein the fourth portion is the same size as the second portion. In some examples, the fourth portion is moved up or down relative to the first portion. In some examples, the second context is the first context. In some examples, the second context is an updated context that is different from the first context. In some examples, the third portion is moved up or down relative to the first portion. In some examples, the device, after selecting the third portion and the fourth portion, performs the first operation using the third portion and the fourth portion.

In some examples, the device, after receiving the first image and the second image, receives, from the first camera, a fifth image of the physical environment, wherein the fifth image is separate from the first image and the second image. In some examples, the device, after receiving the first image and the second image, receives, from the second camera, a sixth image of the physical environment, wherein the sixth image is separate from the first image, the second image, and the fifth image, and wherein the sixth image includes a third overlapping field of view with respect to the fifth image. In some examples, the device, based on a third context of the device, selects a fifth portion, from the fifth image, of the third overlapping field of view, wherein a portion of the fifth image corresponding to the first portion is a different area within the third overlapping field of view, wherein the fifth portion is a different size compared to the first portion. In some examples, the device, based on the third context of the device, selects a sixth portion, from the sixth image of the third overlapping field of view, wherein a portion of the sixth image corresponding to the second portion is a different area within the third overlapping field of view, wherein the sixth portion is a different size compared to the second portion. In some examples, the fourth portion is widened or narrowed relative to the first portion. In some examples, the third context is the first context and/or the second context. In some examples, the third context is an updated context that is different from the first context. In some examples, the fifth portion is widened or narrowed relative to the first portion. In some examples, the device, after selecting the fifth portion and the sixth portion, performs the first operation using the fifth portion and the sixth portion.

In some examples, the context is determined using (e.g., based on) an image captured by the first camera before the first image (e.g., a gradient of a surface). In some examples, the context is determined using multiple images, including an image captured by the first camera before the first image and an image captured by the second camera before the second image.

In some examples, the context is determined using (e.g., based on) an image captured by a third camera different from the first camera and the second camera. In some examples, the context is determined using (e.g., based on) a speed of the device (e.g., a ground speed, such as the speed of the device relative to a surface). In some examples, the context is determined using a direction that the device is heading. In some examples, the context is determined using (e.g., based on) a predicted direction of the device (e.g., a direction at which the device (or another device, such as a service) has determined to head at a later time). In some examples, the context is determined using (e.g., based on) a current state of a component of the device (e.g., a steering wheel or a suspension). In some examples, the context is determined using (e.g., based on) a location of the device. In some examples, the location is determined via a Global Positioning System (GPS). In some examples, the context is determined based on a detected fault state (e.g., a current fault state) of a camera different from the first camera and the second camera.

Note that details of the processes described above with respect to method 500 (e.g., FIG. 5) are also applicable in an analogous manner to the methods described herein. For example, method 600 optionally includes one or more of the characteristics of the various methods described above with reference to method 500. For example, the first portion from method 500 can be the first portion from method 600. For brevity, these details are not repeated below.

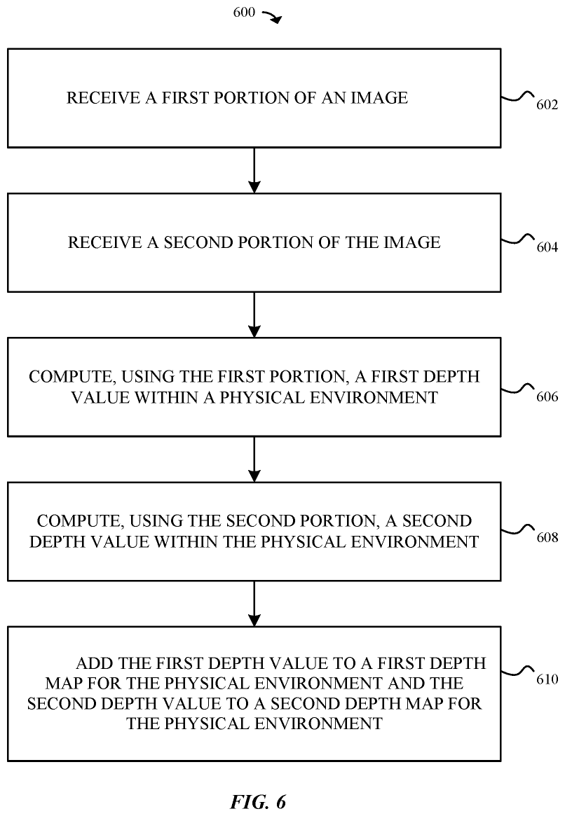

FIG. 6 is a flow diagram illustrating method 600 for separately generating depth maps using images with different resolutions in accordance with some examples described herein. Some operations in method 600 are, optionally, combined, the orders of some operations are, optionally, changed, and some operations are, optionally, omitted.

In some examples, method 600 is performed at a device (e.g., a robotic device, a motorized device, a robot vacuum, and/or an autonomous device). In some examples, the device includes one or more wheels, one or more brakes, one or more steering systems (e.g., a steering system includes an axel), one or more suspension systems (e.g., a suspension system includes a shock absorber), or any combination thercof.

At 602, the device receives a first portion (e.g., a cropped portion) of an image (e.g., a representation of a physical environment), wherein the first portion is a first resolution (e.g., a high resolution or a resolution captured by a camera). In some examples, the first image includes one or more color channels, such as red, green, and blue or an amount of light.

At 604, the device receives a second portion (e.g., an uncropped portion) of the image (e.g., the second portion is the same as or different from the first portion), wherein the second portion is a second resolution lower than the first resolution. In some examples, the second portion is generated by the device.

At 606, the device computes, using the first portion, a first depth value within a physical environment. In some examples, the first depth value is computed based on a disparity between a first camera and a second camera. In some examples, the first depth value is computed using a corresponding portion of a different image captured by a different camera than that used to capture the image. In some examples, the different image is at same resolution as the first portion for calculating the first depth value.

At 608, the device computes, using the second portion, a second depth value within the physical environment. In some examples, the second depth value is computed similar to the first depth value, such as by using the different image captured by the different camera (in some examples, the different image is at same resolution as the second portion for calculating the second depth value).

At 610, the device adds the first depth value to a first depth map for the physical environment and the second depth value to a second depth map for the physical environment, wherein the second depth map is different (e.g., separate) from the first depth map.

In some examples, the device receives, via a camera, the image at a third resolution, wherein the third resolution is greater than the first resolution. In some examples, the device receives, via a camera, the image at a third resolution, wherein the third resolution is greater than the first resolution.

In some examples, the device receives, via a camera, the image at the first resolution (e.g., the image is captured by the camera at the first resolution). In some examples, the device receives, via a camera, the image at the first resolution (e.g., the image is captured by the camera at the first resolution).

In some examples, the second portion includes the first portion (e.g., the second portion is the image in its entirety).

In some examples, the device rectifies the image before generating the second portion. In some examples, the image is captured by a first camera and the image is rectified with a second image captured by a second camera different from the first camera. In some examples, the device rectifies the image before generating the second portion. In some examples, the image is captured by a first camera and the image is rectified with a second image captured by a second camera different from the first camera.

In some examples, the device, before rectifying the image, performs an image analysis operation using the image, wherein the image analysis operation is performed by the same compute node that rectified the image. In some examples, the device, before rectifying the image, performs an image analysis operation using the image, wherein the image analysis operation is performed by the same compute node that rectified the image.

In some examples, the device, after rectifying the image, performs an image analysis operation using the image, wherein the image analysis operation is performed by the same compute node that rectified the image. In some examples, the device, after rectifying the image, performs an image analysis operation using the image, wherein the image analysis operation is performed by the same compute node that rectified the image.

In some examples, the device performs, by a first compute node based on at least one of the first depth or the second depth, an image analysis operation using the image, wherein the first compute node is different from a compute node that computed the first depth value and the second depth value, and an image captured by a camera different from a camera used to capture the image. In some examples, the device performs, by a first compute node based on at least one of the first depth or the second depth, an image analysis operation using the image, wherein the first compute node is different from a compute node that computed the first depth value and the second depth value, and an image captured by a camera different from a camera used to capture the image.

In some examples, the device merges the first depth map and the second map to generate a third depth map (e.g., reconciling overlapping points). In some examples, the device merges the first depth map and the second map to generate a third depth map (e.g., reconciling overlapping points).

Note that details of the processes described above with respect to method 600 (e.g., FIG. 6) are also applicable in an analogous manner to the methods described herein. For example, method 500 optionally includes one or more of the characteristics of the various methods described above with reference to method 600. For example, computing the first depth value in method 600 can be the first operation in method 500. For brevity, these details are not repeated below.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the processing and/or sending of images. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an image processing system. Accordingly, use of such personal information data enables users to have better image processing systems.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image processing services, the present technology can be configured to allow users to select to “opt in” or “opt out” of participation in the collection of personal information data during registration for services or anytime thereafter. In another example, users can select not to provide particular images for image processing services. In yet another example, users can select to limit the length of time image data is maintained or entirely prohibit the development of a profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be provided to users by inferring areas of interest based on non-personal information data or a bare minimum amount of personal information, such as the content being requested by the device associated with a user, other non-personal information available to the image processing services, or publicly available information.

What is claimed is:

1. A method, comprising:
at a device:
receiving a first portion of an image, wherein the first portion is a first resolution;
receiving a second portion of the image, wherein the second portion is a second resolution lower than the first resolution;
computing, using the first portion, a first depth value within a physical environment;
computing, using the second portion, a second depth value within the physical environment; and
adding:
the first depth value to a first depth map for the physical environment; and
the second depth value to a second depth map for the physical environment, wherein the second depth map is different from the first depth map.

2. The method of claim 1, further comprising:
receiving, via a camera, the image at a third resolution, wherein the third resolution is greater than the first resolution.

3. The method of claim 1, further comprising:
receiving, via a camera, the image at the first resolution.

4. The method of claim 1, wherein the second portion includes the first portion.

5. The method of claim 1, further comprising:
rectifying the image before generating the second portion.

6. The method of claim 5, further comprising:
before rectifying the image, performing an image analysis operation using the image, wherein the image analysis operation is performed by the same compute node that rectified the image.

7. The method of claim 5, further comprising:
after rectifying the image, performing an image analysis operation using the image, wherein the image analysis operation is performed by the same compute node that rectified the image.

8. The method of claim 1, further comprising:
performing, by a first compute node based on:
at least one of the first depth or the second depth, an image analysis operation using the image, wherein the first compute node is different from a compute node that computed the first depth value and the second depth value; and
an image captured by a camera different from a camera used to capture the image.

9. The method of claim 1, further comprising:
merging the first depth map and the second map to generate a third depth map.

10. A non-transitory computer-readable storage medium storing one or more programs configured to be executed by one or more processors of a device, the one or more programs including instructions for:
receiving a first portion of an image, wherein the first portion is a first resolution;
receiving a second portion of the image, wherein the second portion is a second resolution lower than the first resolution;
computing, using the first portion, a first depth value within a physical environment;
computing, using the second portion, a second depth value within the physical environment; and
adding:
the first depth value to a first depth map for the physical environment; and
the second depth value to a second depth map for the physical environment, wherein the second depth map is different from the first depth map.

11. A device, comprising:
one or more processors; and
memory storing one or more programs configured to be executed by the one or more processors, the one or more programs including instructions for:
receiving a first portion of an image, wherein the first portion is a first resolution;
receiving a second portion of the image, wherein the second portion is a second resolution lower than the first resolution;
computing, using the first portion, a first depth value within a physical environment;
computing, using the second portion, a second depth value within the physical environment; and
adding:
the first depth value to a first depth map for the physical environment; and
the second depth value to a second depth map for the physical environment, wherein the second depth map is different from the first depth map.
